(19) United States
(12) Patent Application Publication
(10) Pub. No.: US 2008/0254666 A1
(43) Pub. Date: Oct. 16, 2008

(54) ELECTRICAL CONNECTOR AND ASSOCIATED METHODS

(76) Inventors: Gavril Cret, Sterling Heights, MI (US); Shawn Hansen, Kalamazoo, MI (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/870,053

(22) Filed: Oct. 10, 2007

Related U.S. Application Data
(60) Provisional application No. 60/828,853, filed on Oct. 10, 2006.

(51) Int. Cl. H01R 13/62

(52) U.S. Cl. 439/312

(57) ABSTRACT

In one embodiment, an electrical connector comprises a terminal and a connector body. The electrical connector may have a base and at least one resilient terminal beam, the terminal beam including an electrical contact surface and a locking tab at its free end. The connector body may have a cavity configured to house at least a portion of the terminal beam. The cavity may have one or more interior walls with at least one ramp along an interior wall (e.g., that reduces a portion of the cavity in at least one dimension), and a relief positioned at the end of the ramp, wherein the ramp momentarily deflects the resilient terminal beam during insertion of the terminal into the connector body, and the relief provides a reversible locking engagement with the locking tab of the terminal (e.g., fork terminal). Associated methods are also provided.

### RELATED APPLICATIONS

The present application claims the benefit of U.S. Provisional Application Ser. No. 60/828,853, which was filed on Oct. 10, 2006, and which is hereby incorporated by reference in its entirety for all purposes.

### FIELD OF THE INVENTION

The present invention relates generally to electrical connectors. In one embodiment, the present invention relates to electrical connectors for use in the automotive industry.

For the purposes of describing and claiming the present invention the term “ramp” is intended to refer to an incline which may be planar, arcuate, continuous, discontinuous or any combination thereof.

Further, for the purposes of describing and claiming the present invention the term “resilient” (e.g., resilient terminal beam) is intended to refer to a component that may be deflected in a first direction in response to the application of a force and then springs back (at least partially) in a second direction that is essentially opposite to the first direction when the force is removed.

Further still, for the purposes of describing and claiming the present invention the term “relief” is intended to refer to an indentation, hole, or other void into which a component may at least partially protrude.

### BACKGROUND OF THE INVENTION

Terminal position assurance members are commonly used in electrical connectors in the automotive industry. Improperly assembled electrical connectors pose a problem, for example, in any application in which electrical connectors must be assembled on a power distribution box or wiring harness. If one terminal is not properly positioned, the entire electrical system can be defective and considerable time and effort may be necessary to diagnose this problem.

### BRIEF DESCRIPTION OF THE DRAWINGS

FIG. 1 is a plan view of an electrical terminal having two terminal beams (sometimes referred to herein as a “fork terminal”) according to an embodiment of the present invention;

FIG. 2 is an enlarged plan view of a portion of the terminal of FIG. 1;

FIG. 3 is a plan view of another type of terminal (sometimes referred to herein as a “male terminal”) according to an embodiment of the present invention;

FIG. 4 is a cross-sectional view of a portion of an electrical connector according to an embodiment of the present invention (the electrical connector of this view includes the terminals of FIGS. 1 and 3 and a connector body);

FIG. 5 is an enlarged cross-sectional view of a portion the electrical connector of FIG. 4;

FIG. 6 is an end view of the electrical connector of FIG. 4;

FIG. 7 is a cross-sectional view of a portion of an electrical connector according to another embodiment of the present invention;

FIG. 8 is a cross-sectional view of the electrical connector of FIG. 7 along section line VIII-VIII;

FIG. 9 is a cross-sectional view of the electrical connector of FIG. 7 along section line IX-IX;

FIG. 10 is a perspective cross-sectional view of a portion of the electrical connector of FIG. 7; and

FIG. 11 is an end view of the electrical connector of FIG. 7.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

One embodiment of the present invention provides an electrical connector having at least one terminal position assurance structure that eliminates the need for resilient locking arms formed into the connector body (e.g., a polymer connector body).

Another embodiment of the present invention eliminates the expense associated with the typically high-cost flexible polymers required for forming one or more resilient locking arms as part of a terminal position assurance member.

Another embodiment of the present invention may apply to terminal position assurance members used in electrical connectors in the automotive industry in any application in which electrical connectors must be assembled on a power distribution box, wiring harness, or the like.

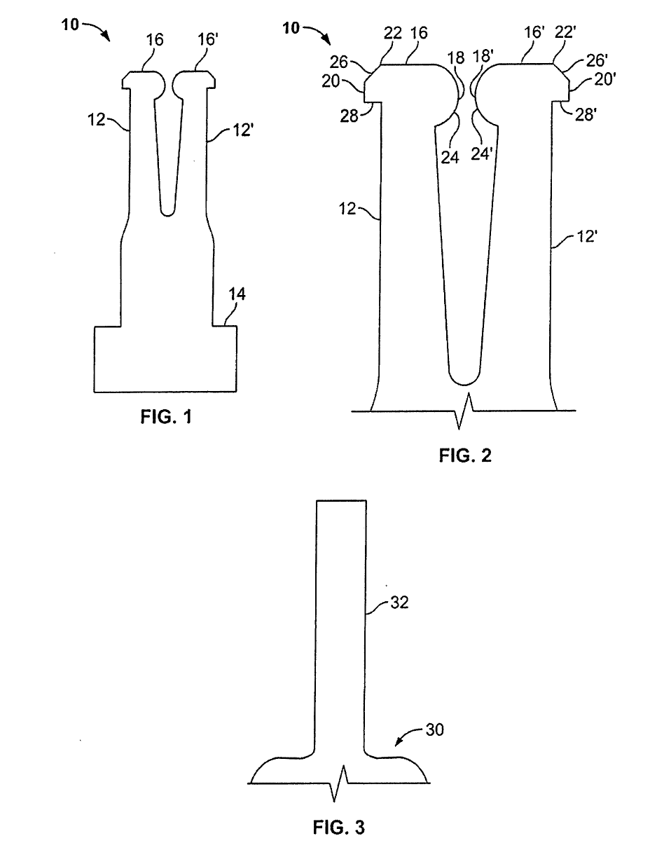

Referring now to FIGS. 1 and 2 (wherein an enlarged portion of FIG. 1 is shown in FIG. 2), a terminal 10 (also referred to sometimes as a “fork terminal”) having at least two substantially co-planar resilient terminal beams 12, 12′ extending outward from a base 14 is shown. The terminal beams 12, 12′ may be spaced apart at their free ends 16, 16′ and along a substantial portion of their lengths. The free ends 16, 16′ may be shaped such that they approach each other closely at their respective inner edges 18, 18′, which face each other. In one example, the inner edges 18, 18′ may have an arcuate shape. The free ends 16, 16′ may also be provided with locking tabs 20, 20′ (which may face away from the inner edges 18, 18′). Each of the inner edges 18, 18′ may have an exposed electrically conductive surface 24, 24′. The terminal 10 may be constructed to provide an electrically conductive path (not shown) through the entire terminal 10 from the inner edges 18, 18′ through the base 14. The electrically conductive path comprises one or more electrically conductive materials, such as (for example) a copper alloy composed of less than 0.5 wt % Zr. In another example, terminal 10 may be formed from sheet material in a stamping operation.

Referring now more specifically to FIG. 2, the locking tabs 20, 20′ may include locking tab ramps 26, 26′ that are arranged such that the free ends 16, 16′ would be pushed toward each when each locking tab ramp 26, 26′ is slid along a contacting surface (not shown here but discussed below). The locking tabs 20, 20′ may include locking edges 28, 28′ adapted to lockingly engage appropriate surfaces (e.g., surfaces that are substantially complementary in shape to the locking edges 28, 28′).

Referring now to FIG. 3, there is shown another terminal 30 (also referred to sometimes as a “male terminal”) having a single terminal beam 32 which extends outward. Terminal 30 may be adapted to be mated (e.g., electrically and mechanically mated) with terminal 10. The terminal beam 32 of terminal 30 may have a thickness that is greater than the spacing between the free ends 16, 16′ of the terminal beams 12, 12′ of the terminal 10. Terminal beam 32 of terminal 30 may be made of an electrically conductive material but is not necessarily resilient. As terminal beam 32 of terminal 30 is inserted between the terminal beams 12, 12′ of the terminal 10, terminal beam 32 may urge the free ends 16, 16′ to move away from each other, while remaining in contact with terminal beam 32. Thus, a positive electrical contact may be maintained between the terminal 10 and the terminal 30.

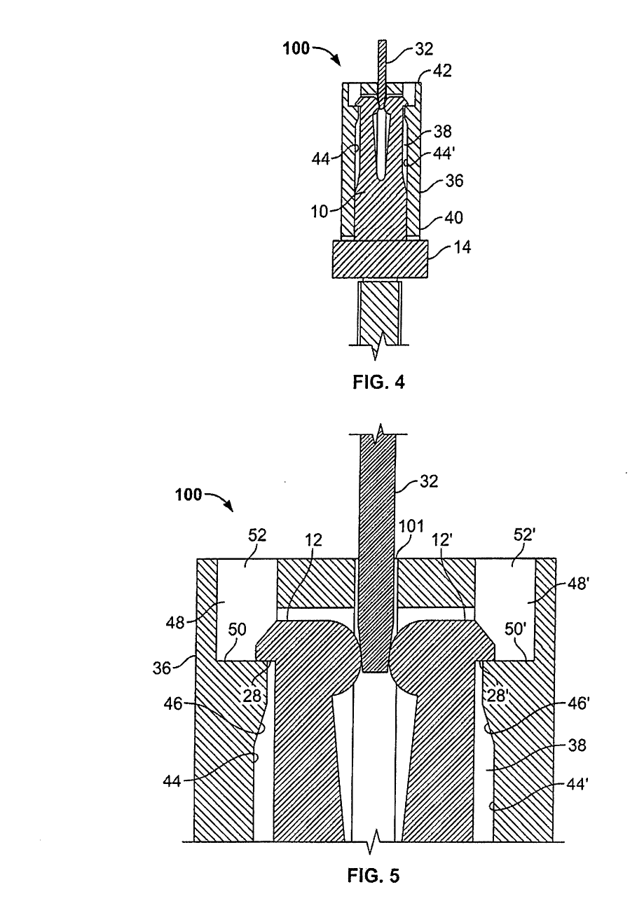

Referring now to FIGS. 1 and 4, base 14 of terminal 10 may be configured to provide a surface for attaching terminal 10 to an electrically conductive member (e.g., a wire). The attachment of base 14 to the electrically conductive member may be made by forming a mechanical connection (e.g., such as by a nut and bolt arrangement), by crimping the base to the wire, and/or by forming a welded engagement (e.g., such as by friction stir welding or ultrasonic welding). The manner of attaching base 14 to the electrically conductive member is, of course, not limited to those mentioned above. Any appropriate form of connectivity is within the scope of the present invention as long as an electrically conductive path is formed between the electrically conductive member and terminal 10. Additional means may be provided to attach base 14 to the insulation that surrounds the electrically conductive member. (e.g., a wire).

Referring now specifically to FIGS. 4 and 5, it is seen that in one embodiment an electrical connector 10 may comprise terminal 10 as well as connector body 36 (in one example, connector body 36 may be made of an electrically insulating material, such as a polymer). Terminal beam 32 of terminal 30 is also shown in position between the free ends 16, 16′ of terminal beams 12, 12′. Connector body 36 may include cavity 38 that extends from a first end 40 of connector body 36 to a second end 42 of connector body 36 that is opposed to first end 40. Cavity 38 may be configured so as to receive terminal beams 12, 12′ of terminal 10 through the first end 40 of connector body 36, and to house at least a portion of terminal 10 in the cavity 38. Further, cavity 38 may have opposed sidewalls 44, 44′ that are arranged such that the plane of terminal beams 12, 12′ of first terminal 10 is substantially perpendicular to sidewalls 44, 44′ when the terminal beams 12, 12′ are inserted into the cavity 38. At least one of the sidewall, 44, 44′ may be provided with an integral connector body ramp 46, 46′ that slopes away from the sidewall 44, 44′ in the direction from the first end 40 of connector body 36 to the second end 42, thus progressively decreasing the width (i.e., the distance between the sidewalls 44, 44′) of cavity 38. At the end of the connector body ramp 46, 46′ may be a relief 48, 48′ that is formed to widen (e.g., abruptly widen) cavity 38. Each relief 48, 48′ may be provided with engagement wall 50, 50′ that is, for example, substantially perpendicular to the sidewall 44, 44′.

In this embodiment, each connector body ramp 46, 46′ provides a fixed surface against which each locking tab ramp 26, 26′ may slide as terminal 10 is inserted into connector body cavity 38, thus deflecting free ends 16, 16′ of terminal 10 towards each other while terminal beams 12, 12′ remain substantially in the same plane. As the locking edge 28, 28′ of each locking tab 20, 20′ moves into a respective relief 48, 48′, the free ends 16, 16′ spring apart (e.g., to their original spacing), and each locking edge 28, 28′ lockingly engages respective engagement wall 50, 50′ of each relief 48, 48′.

Referring now to FIG. 5, an enlarged view of a portion of FIG. 4 depicting locking tabs 20, 20′ of terminal beams 12, 12′ engaging with engagement walls 50, 50′ of each relief 48, 48′ is shown. In the embodiment shown, the locking edges 28, 28′ of terminal beams 12, 12′ engage engagement walls 50, 50′ of each relief 48, 48′ and can not be disengaged while terminal beam 32 of terminal 30 is in contact with the inner edges 18, 18′ of the free ends 16, 16′ of terminal 10. It can be seen in this embodiment that, at second end 42 of connector body 36, cavity 38 divides into at least two openings 52, 52′ (also sometimes referred to as “service openings” or “ports”). These service openings 52, 52′ may be positioned so as to expose at least the locking tab ramps 26, 26′ of locking tabs 20, 20′.

Cavity 38 may also be exposed through the opening through which terminal 30 is received. In this regard, terminal beam 32 of terminal 30 may be inserted into the opening 101 (also sometimes referred to herein as the “male receptacle”) and between inner edges 18, 18′ of free ends 16, 16′ of terminal 10. Terminal beam 32 of terminal 30 may thus blocks free ends 16, 16′ from being moved toward each other. Once terminal beam 32 of terminal 30 is removed from between inner edges 18, 18′ of free ends 16, 16′ of terminal 10, (e.g., removed from connector body 36), each locking tab 20, 20′ can be released from its engagement with each respective engagement wall 50, 50′ of each relief 48, 48′ (e.g., by inserting a tool such as a small screw driver into the corresponding opening 52, 52′ to urge the locking tabs 20, 20′ to move toward each other to disengage the locking tabs 20, 20′ from the engagement walls 50, 50′.

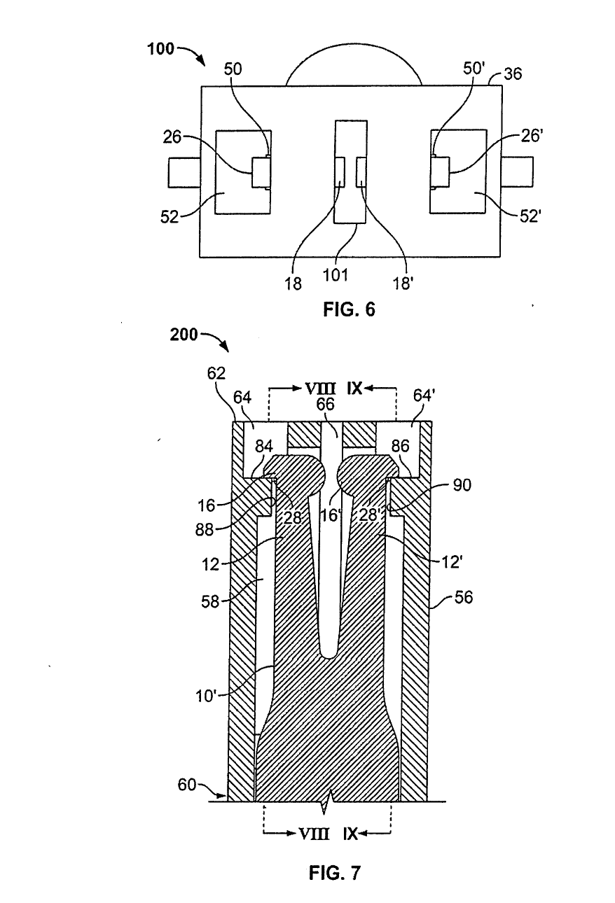

FIG. 6 is an end view of the connector body 36 showing the service openings 52, 52′ and the opening 101 which receives terminal 30, as well as other features that may be seen in end view.

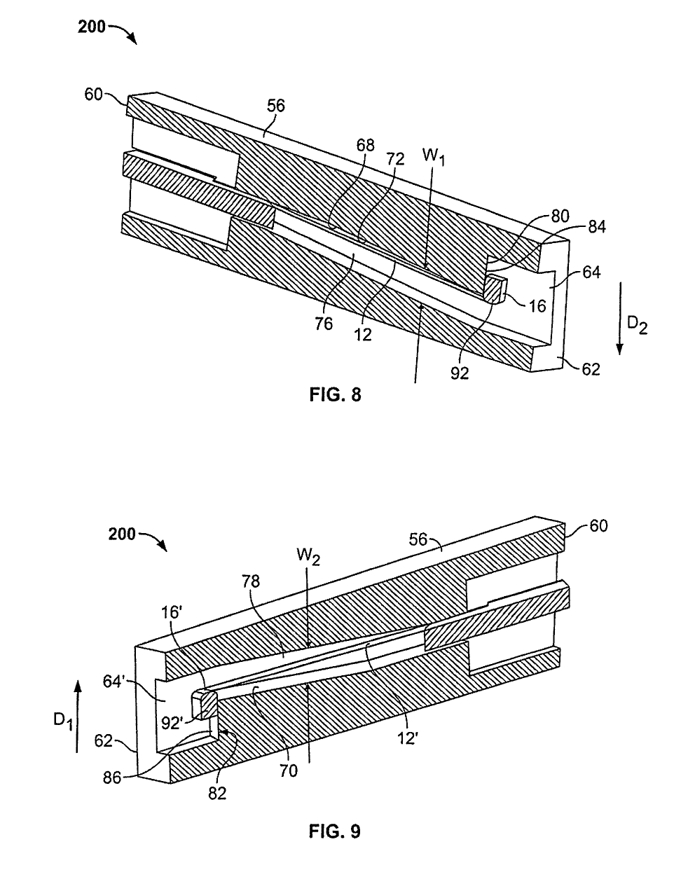

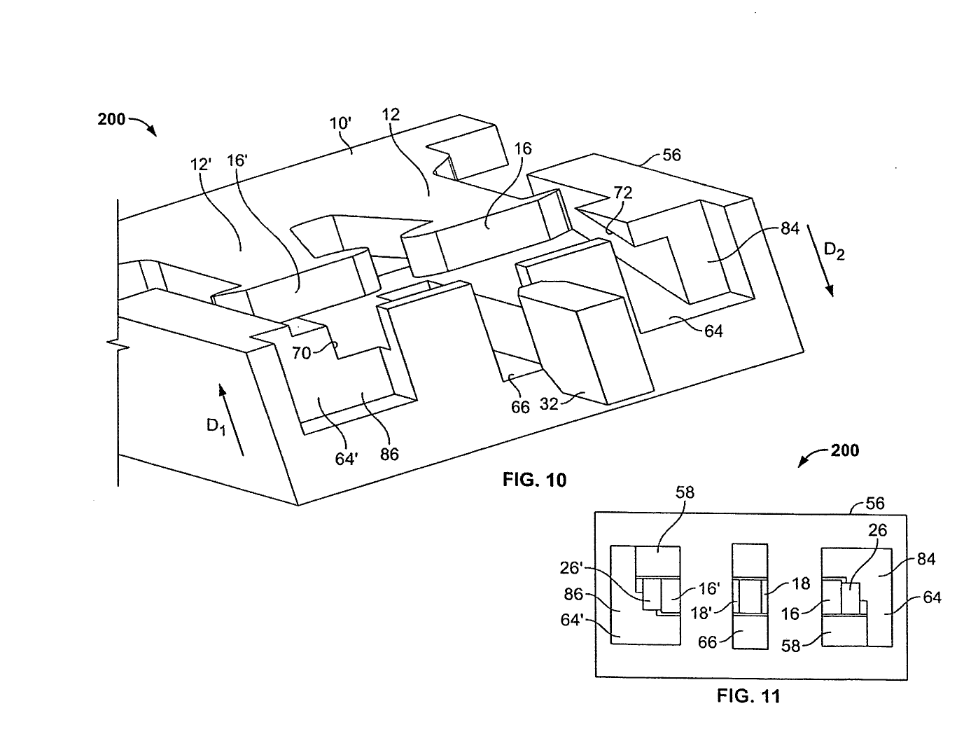

Referring now to FIGS. 7-11, it is seen that these Figs. are directed to a second embodiment of an electrical connector 200 comprising terminal 10′ (similar to terminal 10 previously discussed but with certain differences discussed below) and a connector body 56 (in one example, connector body 56 may be made of an electrically insulating material, such as a polymer). As may be seen, for example, in FIG. 7, connector body 56 may include cavity 58 that extends from a first end 60 of connector body 56 to a second end 62 of connector body 56 that is opposed to the first end 60. At the second end 62 of connector body 56, cavity 58 may be exposed through at least two openings 64, 64′ (also sometimes referred to as “service openings” or “ports”) and another opening 66 (which may also sometimes be referred to herein as the “male receptacle”) for receiving a terminal beam of a male terminal. Cavity 58 may be configured so as to receive terminal beams 12, 12′ of terminal 10′ through first end 60 of connector body 56, and to house at least a portion of terminal 10′.

Cavity 58 may be further provided with a connector body ramp 70 (which may, for example, be integral) and/or a connector body ramp 72 (which may, for example, be integral). Each of connector body ramps 70,72 may slope in opposing directions. Each wall opposite each connector body ramp 70, 72 may have a slope that is complementary to the connector body ramp 70, 72 such that a respective channel 76, 78 of constant width W₁, W₂ is formed. At the end of connector body ramp 70, 72 may be respective relief 80, 82 (each having an engagement wall 84, 86). It can be seen that a step 88, 90, which may be continuous with the respective engagement wall 84, 86, may be provided at each relief 80, 82 to engage locking edge 28, 28′ of free end 16, 16′ of respective terminal beam 12, 12′ of terminal 10′.

Each connector body ramp 70, 72 may provide a fixed surface against which free end 16, 16′ of each of terminal beam 12, 12′ of terminal 10′ may slide as terminal 10′ is inserted into the connector body cavity 58. To facilitate the sliding of each free end 16, 16′ along the connector body ramp 70, 72, each free end 16, 16′ may be provided with a thickened portion 92, 92′ that contacts each respective connector body ramp 70, 72 as each free end 16, 16′ slides. Because of the arrangement of each of connector body ramp 70, 72, each of free ends 16, 16′ may be deflected out of the plane defined by the unstressed terminal beams 12, 12′ of terminal 10′. As each locking edge 28, 28′ of each locking tab 20, 20′ moves into each respective relief 80,82, each free end 16, 16′ springs back (e.g., into a position that is substantially the same as its original position), such that its respective locking edge 28, 28′ lockingly engages each engagement wall 84, 86. The thickened portion 92, 92′, when present, may improve the engagement of each free end 16, 16′ with each engagement wall 84, 86.

In distinction over the connector body 36 shown in FIGS. 4-6, in which connector body ramps 46, 46′ are arranged to urge free ends 16, 16′ of terminal beams 12, 12′ together without substantially deflecting them out of their common plane, the connector body ramps shown in FIGS. 7-11 are arranged to deflect each of free ends 16, 16′ of each of terminal beams 12, 12′ in opposing directions D1, D2.

FIG. 10 shows a perspective view of terminal 10′ and connector body 56 near second end 62 of connector body 56.

FIG. 11 is an end view of second end 62 of connector body 56 showing service openings 64, 64′ and opening 66 for terminal beam 32 of second terminal 30, as well as other features of the connector that may be seen in end view. Similar to the embodiment shown in FIG. 6, the service openings 64, 64′ expose at least locking tab ramps 26, 26′ of locking tabs 20, 20′. As with the connector of FIGS. 4-6, an electrical contact is made between terminal 10′ and terminal 30 by inserting terminal beam 32 of terminal 30 into the opening 66 and between inner edges 18, 18′ of free ends 16, 16′ of terminal 10′. Once terminal beam 32 is removed from between inner edges 18, 18′ of free ends i6, 16′ of terminal 10′ (e.g., removed from connector body 56), each locking tab 20, 20′ may be released from its engagement with each engagement wall 84, 86 and each relief 80, 82 (e.g., by inserting a tool such as a small screwdriver into the corresponding opening 66, 66′ to disengage locking tabs 20, 20′ from engagement walls 84, 86).

In general (and with respect to each of the embodiments described above), to provide electrical connectivity, free ends 16, 16′ of terminal 10,10′ may be inserted into cavity 38, 58 at first end 40, 60 of connector body 36, 56. Terminal 10,10′ may be advanced forward into cavity 38, 58 toward the second end 42, 62 of connector body 36, 56 until the locking edges 28, 28′ of the locking tabs 20, 20′ engage the respective engagement walls 50, 50′, 84, 86 of each relief 48, 48′, 80, 82. Terminal beam 32 of terminal 30 may then be inserted into male receptacle 54, 66 so as to engage the electrically conductive surfaces 24, 24′ of free ends 16, 16′ of terminal beams 12, 12′ of terminal 10,10′ (the end of terminal beam 32 of terminal 30 may be chamfered, narrowed, or the like to aid in insertion)

To break the electrical connection, terminal beam 32 of terminal 30 may be disengaged from the electrically conductive surfaces 24, 24′ of terminal beams 12, 12′ of terminal 10,10′ (terminal beam 32 may be withdrawn partially or entirely through the respective male receptacle 54, 66). The electrical connector may then be disassembled by inserting a small tool through service openings 52, 52′, 64, 64′ to urge the locking tabs 20, 20′ away from engagement walls 50, 50′, 84, 86, and withdrawing terminal 10,10′ from cavity 38, 58 through first end 40, 60 of connector body 36, 56.

In another embodiment, the male terminal will not fit in between the two terminal beams unless the two terminal beams are in the proper position (e.g., pushed all the way into the connector body with each locking tab in a respective relief).

While a number of embodiments of the present invention have been described, it is understood that these embodiments are illustrative only, and not restrictive, and that many modifications may become apparent to those of ordinary skill in the art. For example, any element described herein may be provided in any desired size (e.g., any element described herein may be provided in any desired custom size or any element described herein may be provided in any desired size selected from a “family” of sizes, such as small, medium, large). Further, any steps described herein may be carried out in any desired order (and any additional steps may be added as desired and/or any steps may be deleted as desired).

What is claimed is:

1. An electrical connector, comprising:
a terminal with a base and at least first and second resilient terminal beams extending from the base, wherein each of the first and second terminal beams includes an electrical contact surface and a locking tab;
a connector body with a cavity, wherein the cavity is configured for housing at least a portion of the terminal;
a first ramp along at least a portion of an interior surface of the cavity;
a first relief positioned adjacent the first ramp;
a second ramp along at least a portion of the interior surface of the cavity;
a second relief positioned adjacent the second ramp;
wherein the first ramp deflects the first terminal beam during insertion of the first terminal beam into the cavity and wherein the first relief provides a locking engagement with the locking tab of the first terminal beam when the locking tab of the first terminal beam passes the first ramp and the first terminal beam at least partially un-deflects towards the first relief; and
wherein the second ramp deflects the second terminal beam during insertion of the second terminal beam into the cavity and wherein the second relief provides a locking engagement with the locking tab of the second terminal beam when the locking tab of the second terminal beam passes the second ramp and the second terminal beam at least partially un-deflects towards the second relief.

2. The connector of claim 1, wherein the first and second ramps deflect the first and second terminal beams towards one another as the first and second terminal beams are inserted into the cavity.

3. The connector of claim 1, wherein the first ramp deflects the first terminal beam in a first direction as the first terminal beam is inserted into the cavity, wherein the second ramp deflects the second terminal beam in a second direction as the second terminal beam is inserted into the cavity, and wherein the first direction and the second direction are essentially opposite to one another.

4. The connector of claim 1, wherein the first ramp reduces, from a first portion of the first ramp to a second portion of the first ramp, the size of the cavity and wherein the second ramp reduces, from a first portion of the second ramp to a second portion of the second ramp, the size of the cavity.

5. The connector of claim 1, wherein the locking arrangement of the first relief with the locking tab of the first terminal beam is releasable and wherein the locking arrangement of the second relief with the locking tab of the second terminal beam is releasable.

6. The connector of claim 1, wherein an opening is provided in the connector body to allow insertion of at least a portion of a male connector into the cavity, wherein the male connector makes electrical contact with the electrical contact surfaces of each of the first and second terminal beams.

7. The connector of claim 6, wherein a space is provided between at least a portion of each of the first and second terminal beams to allow the male connector to make electrical contact with the electrical contact surfaces of each of the first and second terminal beams at the space provided between each of the first and second terminal beams.

8. The connector of claim 7, wherein the male connector, when contacting the electrical contact surfaces of each of the first and second terminal beams at the space provided between each of the first and second terminal beams, prohibits the first terminal beam from deflecting away from the first relief and prohibits the second terminal beam from deflecting away from the second relief.

9. The connector of claim 1, wherein:
the electrical contact surface of the first terminal beam is disposed at a distal end of the first terminal beam;
the locking tab of the first terminal beam is disposed at the distal end of the first terminal beam;
the electrical contact surface of the second terminal beam is disposed at a distal end of the second terminal beam; and
the locking tab of the second terminal beam is disposed at the distal end of the second terminal beam.

10. The connector of claim 9, wherein:
the electrical contact surface of the first terminal beam and the locking tab of the first terminal beam are disposed at the distal end of the first terminal beam essentially opposite of one another; and
the electrical contact surface of the second terminal beam and the locking tab of the second terminal beam are disposed at the distal end of the second terminal beam essentially opposite of one another.

11. The connector of claim 1, wherein the first ramp includes at least one essentially planar portion along a length of the first ramp which does not additionally deflect the first terminal beam and wherein the second ramp includes at least one essentially planar portion along a length of the second ramp which does not additionally deflect the second terminal beam.

12. The connector of claim 11, wherein the essentially planar portion of the first ramp is adjacent the first relief and wherein the essentially planar portion of the second ramp is adjacent the second relief.

13. The connector of claim 1, wherein the electrical contact surface of the first terminal beam includes an arcuate geometry and the electrical contact surface of the second terminal beam includes an arcuate geometry.

14. The connector of claim 1, wherein the locking tab of the first terminal beam comprises a ramp portion and the locking tab of the second terminal beam comprises a ramp portion.

15. The connector of claim 1, wherein the base of the terminal is electrically connected to a wire by a friction stir weld.

16. The connector of claim 1, wherein the base of the terminal is electrically connected to a wire by a mechanical connection.

17. The connector of claim 1, wherein the base of the terminal is electrically connected to a wire by a crimped connection.

18. The connector of 1, wherein the terminal comprises a copper alloy.

19. The connector of claim 1, wherein the connector body comprises an insulating polymer.

20. The connector of claim 1, wherein the connector body further comprises at least one port providing access to the locking tab of at least one of the first and second terminal beams.

21. An electrical connector, comprising:
a terminal with a base and at least one resilient terminal beam extending from the base, wherein the terminal beam includes an electrical contact surface and a locking tab;
a connector body with a cavity, wherein the cavity is configured for housing at least a portion of the terminal;
at least one ramp along at least a portion of an interior surface of the cavity; and
at least one relief positioned adjacent the ramp;
wherein the ramp deflects the terminal beam during insertion of the terminal beam into the cavity and wherein the relief provides a locking engagement with the locking tab of the terminal beam when the locking tab of the terminal beam passes the ramp and the terminal beam at least partially un-deflects towards the relief.

22. A method of providing electrical connectivity, comprising:
providing a connector body including a first opening for insertion of a male terminal, a second opening for insertion of a female terminal, and a cavity comprising an interior surface having at least a first ramp and a second ramp, wherein the first ramp leads to a first relief, and wherein the second ramp leads to a second relief;
inserting at least a portion of the female terminal into the second opening, the female terminal comprising at least a first resilient terminal beam having an electrical contact surface and at least one locking tab and at least a second resilient terminal beam having an electrical contact surface and at least one locking tab, wherein the first ramp deflects the first terminal beam during insertion of the first terminal beam into the cavity, wherein the first relief provides a locking engagement with the locking tab of the first terminal beam when the locking tab of the first terminal beam passes the first ramp and the first terminal beam at least partially un-deflects towards the first relief, wherein the second ramp deflects the second terminal beam during insertion of the second terminal beam into the cavity, and wherein the second relief provides a locking engagement with the locking tab of the second terminal beam when the locking tab of the second terminal beam passes the second ramp and the second terminal beam at least partially un-deflects towards the second relief; and
inserting the male connector into the first opening into electrical contact with the electrical contact surfaces of each of the first and second terminal beams.

23. The method of claim 22, wherein the male terminal, when contacting the electrical contact surfaces of each of the first and second terminal beams at a space provided between each of the first and second terminal beams, prohibits the first terminal beam from deflecting away from the first relief and prohibits the second terminal beam from deflecting away from the second relief.

24. A method of providing electrical connectivity, comprising:
providing a connector body including an opening for insertion of a terminal and a cavity comprising an interior surface having at least one ramp, wherein the ramp leads to a relief;
inserting the terminal into the opening, the terminal comprising at least one resilient terminal beam having an electrical contact surface and at least one locking tab, wherein the ramp deflects the terminal beam during insertion of the terminal beam into the cavity, and wherein the relief provides a locking engagement with the locking tab of the terminal beam when the locking tab of the terminal beam passes the ramp and the terminal beam at least partially un-deflects towards the relief.
